(19) United States
(12) Patent Application Publication
(10) Pub. No.: US 2011/0022899 A1
(43) Pub. Date: Jan. 27, 2011

(54) PRODUCING OR EXECUTING A SCRIPT FOR AN OPERATION TEST OF A TERMINAL SERVER

(76) Inventors: Vitali Greenberg, Modiin (IL); Reuven Siman Tov, Jerusalem (IL); Michael Guzman, Beer Sheva (IL); Moshe E. Kraus, Mazkeret Batya (IL); Dorit Naparstek, Tel Aviv (IL); Einat V. Zilber, Givatayim (IL); Sergey Kutsos, Odessa (UA)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/510,048

(22) Filed: Jul. 27, 2009

(51) Int. Cl. G06F 11/00; G06F 15/173

(52) U.S. Cl. 714/47; 709/224; 714/E11.02

(57) ABSTRACT

A method of or system for producing or executing a script for a load test of a terminal server. During execution of a high-level application by the terminal server controlled by a user of a terminal client in which the terminal client and terminal server communicate according to remote-desktop protocol, a terminal-services agent on the terminal server may monitor a change in at least one window of the high-level application within a terminal-client desktop of the terminal client. Window-related information corresponding to the monitored change from the terminal-services agent may be sent to an operation-test tool resident on the terminal client. The operation-test tool may log the received window-related information.

### BACKGROUND

A variety of commercially-available software tools exist for assisting companies in testing the operation, i.e., performance and functionality, of their web-based or other network-based transactional servers and associated applications prior to deployment. Examples of such tools include the LoadRunner®, WinRunner® and Astra QuickTest® products of Hewlett-Packard Corporation, the assignee of the present application.

Using these products, a user can record or otherwise create a test script that specifies a sequence of user interactions with the transactional server. The user may also optionally specify certain expected responses from the transactional server, which may be added to the test script as verification points. For example, the user may record a session with a web-based travel reservation system during which the user searches for a particular flight, and may then define one or more verification points to check for an expected flight number, departure time or ticket price.

Test scripts generated through this process are “played” or “executed” to simulate the actions of users-typically prior to deployment of the component being tested. During this process, an operation-test tool monitors the performance of the transactional server, including determining the pass/fail status of any verification points. Multiple test scripts may be replayed concurrently in a load test to simulate the load of a large number of users. Some operation-test systems may use an automation interface to dispatch test scripts to remote computers for execution.

There is an increasing demand for functional and load testing of Terminal Services environments. Terminal Services is a general term providing operation of a computer remotely. The proprietary Windows Server® system, operating according to the Microsoft standard for Terminal Services communication, known as Remote Desktop Protocol (RDP), is included in the Windows Operating Systems provided by Microsoft Corporation. RDP Terminal Services enables users to access Microsoft Windows-based programs that are installed on a terminal server, in the form of a full Windows desktop. With Terminal Services, users can access a terminal server from within a corporate network or from the Internet.

Terminal Services allows the user to deploy and maintain software and to access and control a remote server in an enterprise environment. Programs are deployed from the terminal server at a central location. When a user accesses a program on a terminal server, the program execution occurs on the server. Communication between the server and user (client) computer follows Remote Desktop Protocol (RDP). Keyboard, mouse, and desktop display information is transmitted over the network. Each user sees only their individual session. The session is managed transparently by the server operating system and is independent of any other client session. Businesses are increasingly using complicated business scenarios involved with a variety of applications running in Terminal Services environments. To test these environments, load test scenarios are long and complicated to prepare and maintain.

A load test process may start with a user recording his or her desired business scenarios. From this recording, the operation-test system automatically generates a script that simulates a single business process. Manually customizing this script enables the user to run it in multiple instances in several scheduling scenarios, such that from the server's point of view, actual load is generated. This phase is not only time consuming but also requires high user skills.

The RDP record-replay architecture is image based and a server operating with the RDP protocol sends the user images, so from the user's view the server state is represented visually. As a component running on the client side, an operation-test system records mouse and keyboard events on one hand, as well as image packets (represented in different formats, such as bitmaps, orders, and glyphs) coming from the server on the other hand.

A feature of an operation-test system is the ability to synchronize the user operations (mouse, keyboard) to the server state as it is represented on the client side. An image comparison technique is used for such synchronization.

### BRIEF DESCRIPTION OF THE DRAWINGS

Features and advantages of examples of methods and systems as disclosed will become apparent by reference to the following detailed description and drawings.

FIG. 1 is a block diagram depicting an example of a network having clients with operation-test tools and a server having terminal-services agents.

FIG. 2 is an illustration of an example of a desktop image on a terminal-client display device.

FIG. 3 is a flow chart illustrating an example of a method of producing or executing script of a load test for a network having a client operation-test tool and a server terminal-services agent.

FIG. 4 is a diagram illustrating an example of a method of opening channels of communication between a client operation-test tool and a server terminal-services agent on a network.

FIG. 5 is a diagram illustrating an example of a method of starting a session of communication between a client operation-test tool and a server terminal-services agent on a network.

FIG. 6 is a diagram illustrating an example of a method of communication between a client operation-test tool and a server terminal-services agent on a network during a session of communication.

FIG. 7 is a diagram illustrating an example of a method of ending a session of communication between a client operation-test tool and a server terminal-services agent on a network.

FIG. 8 is a functional block diagram of an example of a terminal server with terminal-services agents.

FIG. 9 is a functional block diagram of an example of a terminal client with an operation-test tool.

FIG. 10 is a display of an example of a script that may be produced or executed by a client operation-test tool communicating with a server terminal-services agent.

### DETAILED DESCRIPTION

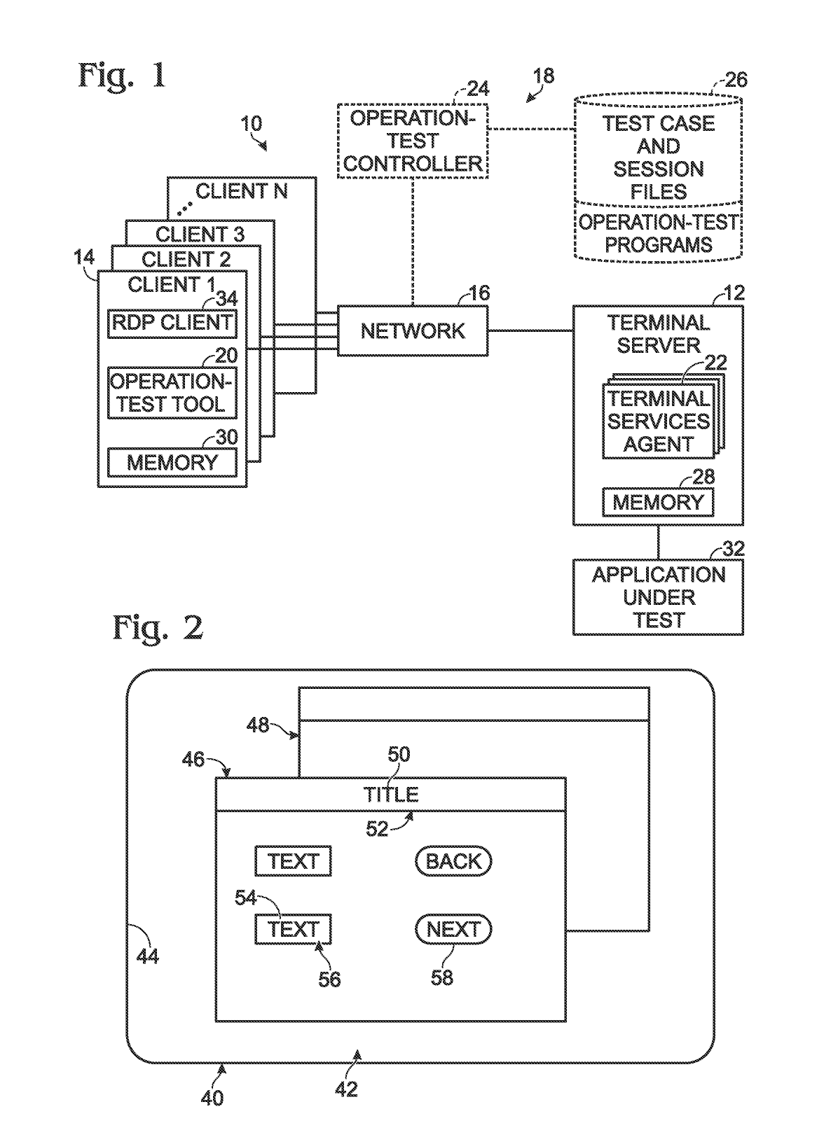

Referring now to the drawings and more particularly to FIG. 1, there is illustrated a block diagram depicting an embodiment of a computer system 10 having one or more terminal server 12, one or more terminal clients 14, and a network 16 providing a communication link between the server§ and client(s) Network system 10 may be configured to include an operation-test system 18. Operation-test system 18 may include an operation-test tool 20 resident on one client 14 or may be resident on each of a plurality of clients 14. The term operation may refer to functionality of a system as well as operation of a system under load. Operation-test system 18 may further include terminal-services agent 22 resident on a terminal server 12. There may be multiple terminal-services agents 22 running on a single terminal server, corresponding to the number of operation-test client sessions currently opened on the terminal server. There also may be multiple terminal servers, and each may have respective terminal-services agents.

Operation-test system 18 may further include an operation-test controller 24 that may be resident on a separate server or may be resident on a terminal client or a terminal server. Operation-test controller 24 may store test-case and/or session files on one or more memory devices, such as a database 26, and accordingly may function as an extension of operation-test tool 20. A memory device, such as database 26, may also store operation-test programs for operation-test system 18.

Terminal server 12 and terminal client 14 may each be any suitable conventional computer that includes a processor, memory devices, and network devices, and if appropriate one or more input/output (I/O) devices. The memory devices, represented by memory 28 in the terminal server and memory 30 in the terminal client, as well as database 26, may be any appropriate computer-readable medium readable by one or more computers. The memory may store data and may have embodied therein programs of computer-readable instructions that may be executed by the one or more computers. The memory may be volatile or non-volatile, fixed or removable, and may include, for example, one or a combination of the following memory devices: a read-only memory (ROM), a random access memory (RAM), a hard drive, a tape drive, a floppy disk, an optical disk, or a flash memory. Memory devices also may be local to each computer and may also be provided through network 16, such as through a remote database and/or database server, as is well known in the art.

I/O devices may include printers, video monitors, liquid-crystal displays (LCD's), touch screen displays, keyboards, keypads, switches, dials, mice, track balls, graphics tablets, voice recognizers, card readers, paper tape readers, or other well-known input/output devices.

Terminal server 12 may control execution of a high-level user or middleware application (software program) under test on an application-under-test device 32. Application-under-test device 32 may be an application server separate from terminal server 12 that executes the application, or it may be part of terminal server 12, with the application stored on a local or remote memory device. The application under test may be executed according to commands input on terminal client 14 by a user as part of a high-level (end-user) transaction or process.

Terminal client 14 and terminal server 12 may communicate via network 16, with terminal client 14 operating as a Remote Desktop Protocol (RDP) client 34. Network 16 may be any suitable network, including a combination of networks, whether wired, wireless, or a combination of wired and wireless, for providing communication between terminal server 12 and terminal client 14, such as one or more local-area networks (LAN) and/or a wide-area network (WAN), such as what is presently known as the Internet.

FIG. 2 illustrates an example of a screen-shot or desktop image 40 provided by terminal server 12 to terminal client 14 during execution of the application under test that is visible to a user on a terminal-client display device. Desktop image 40 may include a background 42 defined by a perimeter 44. Icons (not shown) of applications, files, documents that may be accessed by a user are shown on the background.

Desktop image 40 may also include a window for each application that is running, such as an active window 46 and an inactive window 48. Depending on the size and relative locations of the windows, inactive windows may be completely or partially hidden by the active window, or the inactive window may be visible. The active window is not hidden by other windows and may be completely or partially visible in background 42.

Each window may include various attributes. For example window 46 may have a defined size based on the number of pixels wide and high the window is, a defined position based on how far the window is from the horizontal and vertical perimeter edges of desktop image 40, a title 50 as text in a title bar 52, the text 54 in a text field 56, and a selectable object 58 within the window that may be selected to control execution of the application.

Terminal server 12 may run multiple virtual desktops corresponding to multiple terminal clients 14. Terminal services agent 22 may be automatically loaded during the initiation of a session. This process may run until the end of the session on the server and may work in two modes: record and replay. The terminal services agent may establish one or more channels for communication with operation-test tool 20. For example, two additional virtual communication channels may be established to provide communication with the operation-test tool, in addition to communication between the terminal server and the RDP client 34 of terminal client 14, during record and replay modes.

One virtual communication channel is used to communicate (stream) window information (window state, size, location, title etc) from the terminal-services agent to the operation-test tool. An example of a method 60 for providing the window information is illustrated in FIG. 3. To extract this information, the terminal-services agent may monitor an application window, as shown by step 62. Monitoring the window may include using a hooking mechanism provided by the Win32 application programming interface (API). Every change (visual and non-visual) in the user desktop image may be checked, as represented by step 64. If there has not been a change, monitoring of the window continues. If there has been a change, the change may be sent to the operation-test tool, as illustrated by step 66. Optionally, the changes may be filtered by the terminal services agent, so that selected relevant changes are sent to the client. Changes may be selected for communication based on one or more types of change in the window. Examples of such change types are: window creation, resize, focus, visible, and caption or title change.

The communicated window-change information may then be logged by the operation-test tool 20, as illustrated by step 68. In this way, the client side operation-test tool builds a run-time data structure for all windows with their position (z-order) in the specific RDP session context. Using this information, the client may perform synchronization by window title. The next client operation may then wait until the relevant window appears.

The second virtual communication channel may be used for request-response commands to obtain run-time information from the terminal server as needed. Operation-test tool 20 in terminal client 14 may issue a request for an attribute of a window. The following table lists examples of requests that may be made during the record or replay stages, while the terminal-services agent sends its response according to the current state of the session.

| Function Name | Description |
|---|---|
| get_active_window_title | Retrieves the title and ordinal value of the |
| | active window. |
| get_object_info | Retrieves information about the object at the |
| | specified coordinates. |
| get_option | Retrieves the value of a specified RDP |
| | option in a given connection. |
| get_text | Retrieves the text in the specified point and |
| | saves the text to a parameter. The text can |
| | later be used for correlations. |
| get_window_position | Retrieves the position of a window. |

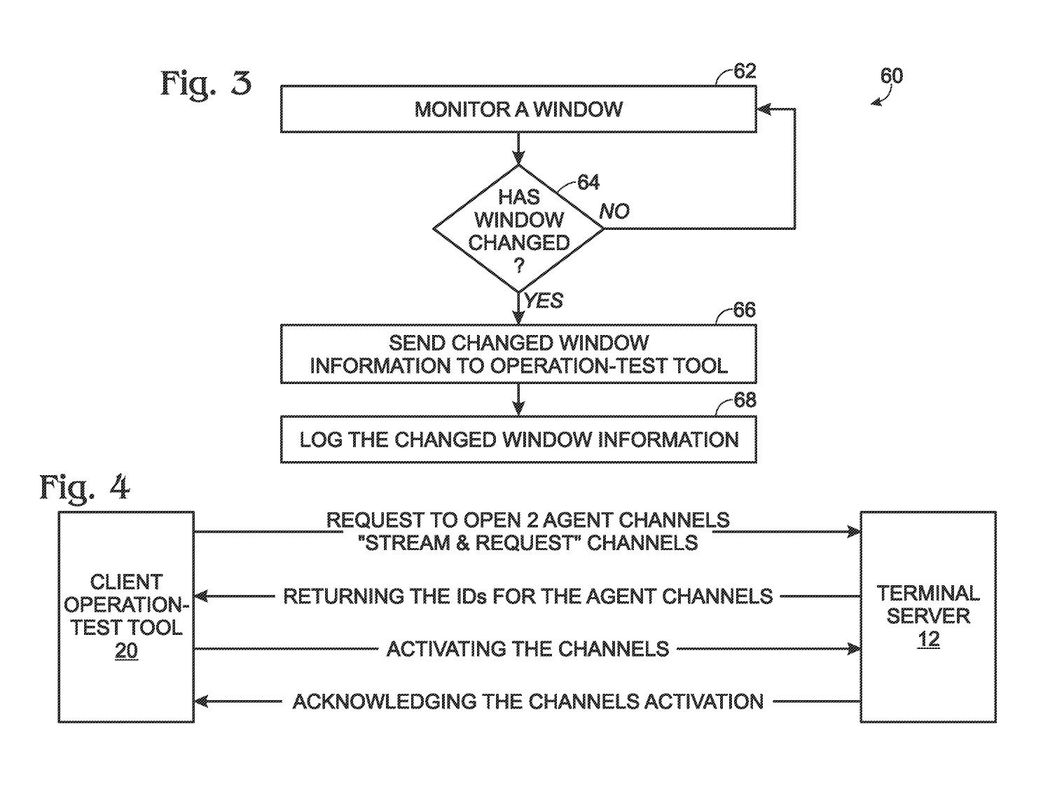

FIGS. 4-7 illustrate examples of communications between operation-test tool 20 and terminal-services agent 22 during a record or playback session. Time progresses from top to bottom in these figures.

FIG. 4 illustrates an example of a connection sequence. The operation-test tool initially may send a request to the terminal services agent to open two new virtual communication channels, one for streaming and one for requests and responses. The terminal server then may return the identifiers for the two communication channels. The operation-test tool then may activate the communication channels, which activation is acknowledged by the terminal server. In one example, the request/response communication channel may be opened first. Then, over the request/response communication channel, the terminal server may be requested to open the streaming communication channel for communicating windows-related information.

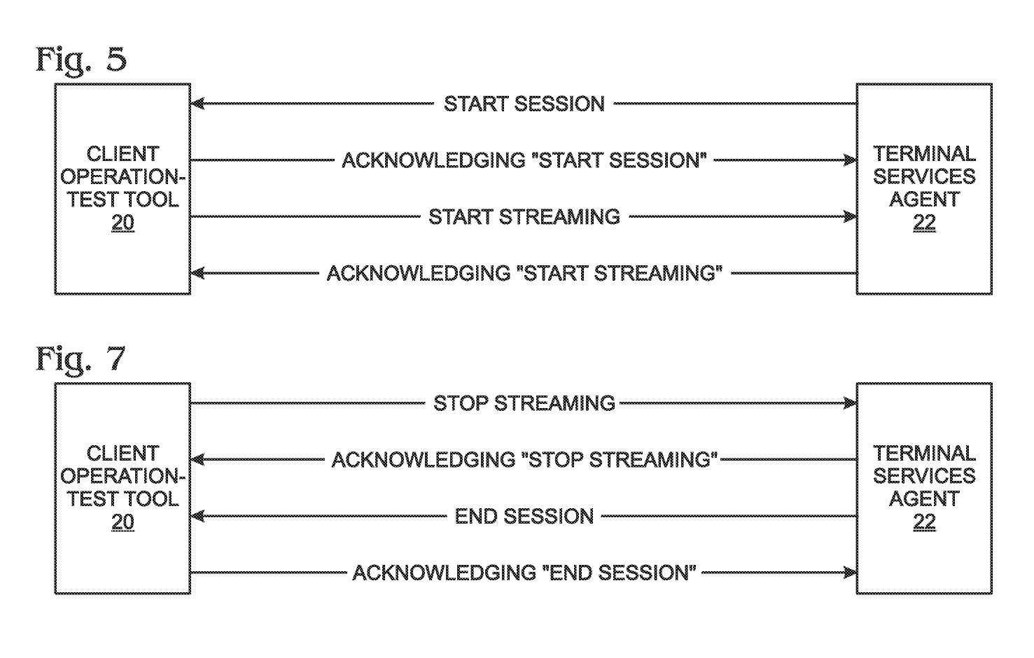

FIG. 5 illustrates an example of a session initialization sequence. Terminal-services agent 22 may send a start session notice and operation-test tool 20 may reply with an acknowledgement. The operation-test tool then may notify the terminal-services agent to start streaming windows information on the streaming virtual communication channel, and the terminal-services agent may acknowledge the start of streaming.

FIG. 6 illustrates a general example of a series of communications that may take place between operation-test tool 20 and terminal-services agent 22 during a record or playback session to illustrate how the two virtual communication channels of communication may be used. A series of successive server-initiated messages from the terminal-services agent may be communicated over the streaming communication channel, as represented by the dashed lines for Window Info (1) through Window Info (8) in this example. All windows in the opened session may be monitored whether or not they belong to an application under test. Accordingly, more than one window may be monitored at a time.

Interspersed in time with the streaming of the window information are a series of user-initiated requests and responses conveyed on the second virtual communication channel represented by the solid lines. These requests enable the operation-test tool to give the terminal services agent specific tasks, like obtaining advanced information about a window or requesting for synchronization on a specific object being in a specified state. This example shows an initial “Get Object Info” request from the operation-test tool followed by a response with the requested information from the terminal-services agent. Next is a request for “Sync on Object Info” with the result then being provided by the terminal-services agent.

A third request/response sequence is then shown in which “Get Text” is requested by the operation-test tool. The terminal-services agent then responds with the requested text. Between the times the fifth and sixth messages are conveyed on the first virtual communication channel, a “Sync on Text” request is sent to the terminal-services agent, and the “Sync on Text” result is conveyed back to the operation-test tool, as shown.

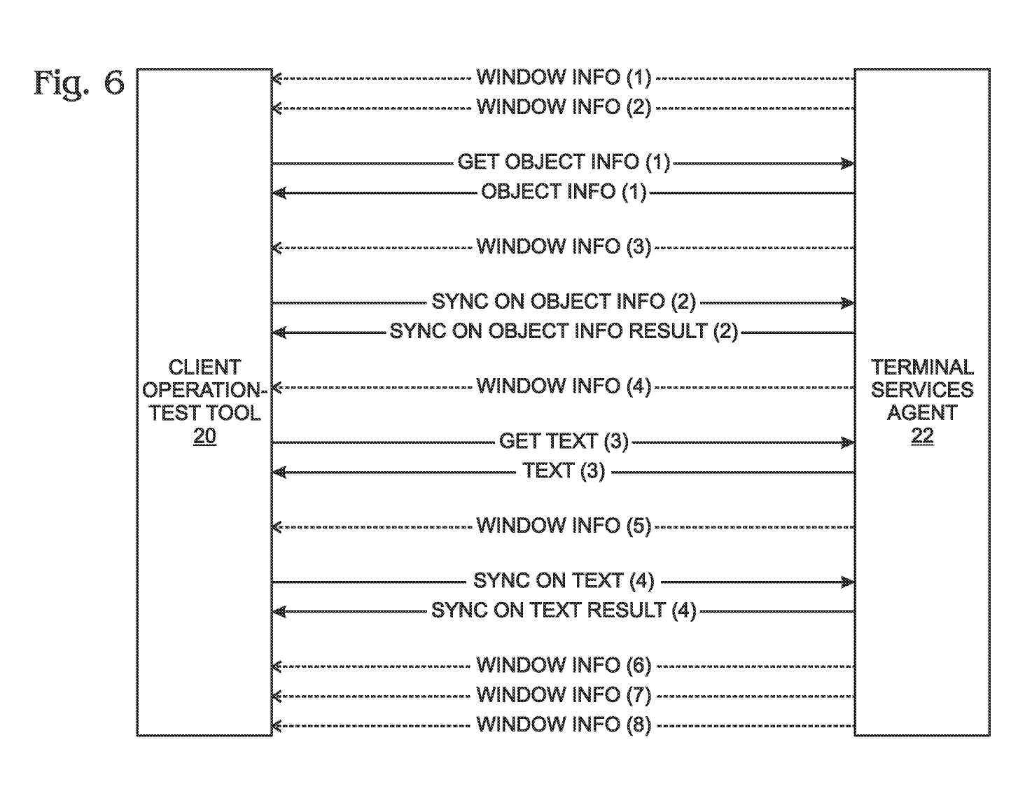

Upon completion of the session, the session may be terminated, such as is illustrated in FIG. 7.This may be accomplished by operation-test tool 20 sending to terminal-services agent 22 an instruction to stop streaming window information. The terminal-services agent may respond with an acknowledgement, which may be followed with an “End Session” instruction to the operation-test tool. Receipt of the instruction may then be acknowledged to the terminal-services agent in the final communication for the session.

Using the window information streaming on the first virtual communication channel and the window information obtained by requests and replies communicated on the second virtual communication channel, associated synchronization steps may be generated, and these steps may be generated automatically. The following table lists examples of synchronization commands that may be produced as part of an operation-test script.

| Function Name | Description |
|---|---|
| sync_object_mouse_click | Waits for an object to have a |
| | specified attribute value, and then |
| | executes a mouse click operation |
| | on the object. |
| sync_object_mouse_double_click | Waits for an object to have a |
| | specified attribute value, and then |
| | executes a mouse double-click |
| | operation on the object. |
| sync_on_agent | Waits until the RDP client locates |
| | a running RDP agent on the RDP |
| | server. |
| sync_on_object_info | Pauses script execution until an |
| | object has the specified attribute |
| | value. |
| sync_on_text | Pauses script execution until a |
| | specified string appears in the |
| | specified area before resuming. |
| sync_on_window | Waits for a window to match a |
| | specified state. |

These commands may be based on Windows OS meta-data information that may exist on terminal server 12. In this example, this meta-data information may describe the visual display in terms of windows and objects, rather than desktop images.

An example of synchronization on window information is the synchronization-by-window-title before keyboard typing. A script may be produced that assures that the relevant window as occurred during recording is ready for the keyboard events.

As another workflow example, while recording, a mouse-click event may be recognized and the operation-test tool may prepare appropriate data to recreate this mouse click on time during replay. For this purpose the following workflow may run. Operation-test tool 20 in terminal client 14 may hold and accumulate any events communicated from the terminal client to the terminal server. It may issue a request for control information to the terminal-services agent according to mouse-click event coordinates. Once the object information is retrieved from the terminal-services agent, the operation-test tool may store or log it for later use, such as during an automatic script generation. The operation-test tool may then send the accumulated events to the terminal server. When the operation-test tool generates the script, this object information may be used to create a synchronization step. As a result, during replay, before performing this mouse click, the operation-test-tool script may provide for confirmation that this specific control exits and is ready for the mouse click. This may result in the mouse-click operation being substantially the same as the one that occurred during recording.

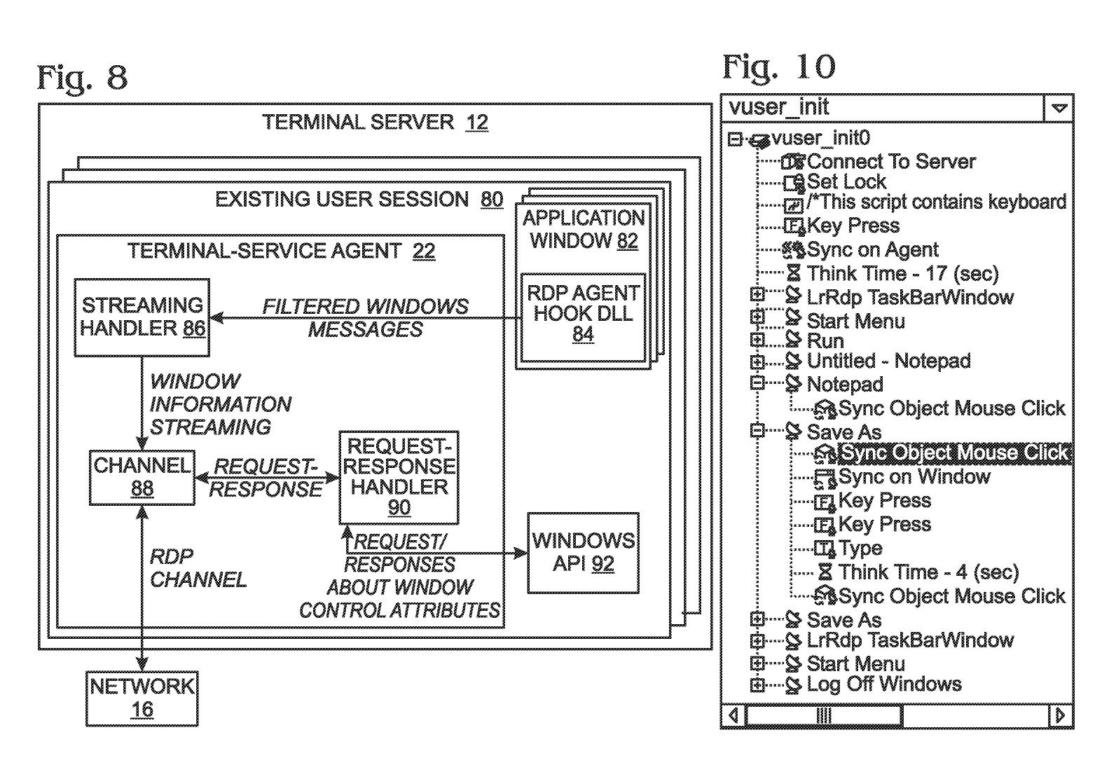

FIG. 8 is a functional block diagram of an example of terminal server 12 with terminal-services agents 22. During operation, the terminal server may have multiple existing RDP user sessions, such as session 80. A terminal services agent 22 may be running for each existing session. Each session 80 may include one or more application windows, such as a window 82 corresponding to window 46 illustrated in FIG. 2. An RDP-agent-hook dynamic-link-library (DLL) routine 84 associated with the application window may provide selected (filtered) window information to a streaming handler 86 for processing messages to be streamed to the operation-test tool. A network interface 88 may provide an interface with network 16. In this instance, network interface 88 may output the windows information on the communication channel identified for streaming windows information.

Network interface 88 also may receive requests for application-window control attributes from the operation-test tool 20 on the communication channel identified for requests and responses. These requests may be routed to a request-response handler 90. The request-response handler then may submits the request to a Microsoft Windows application program interface (API) 92 running as part of the current user session. The Windows API may obtain the requested information about the associated application window and submit it as a response to request-response handler 90. The request-response handler 90 then may formulate a message containing the requested information and submit it to network interface 88. The network interface then outputs the response message on the communication channel identified for requests and responses.

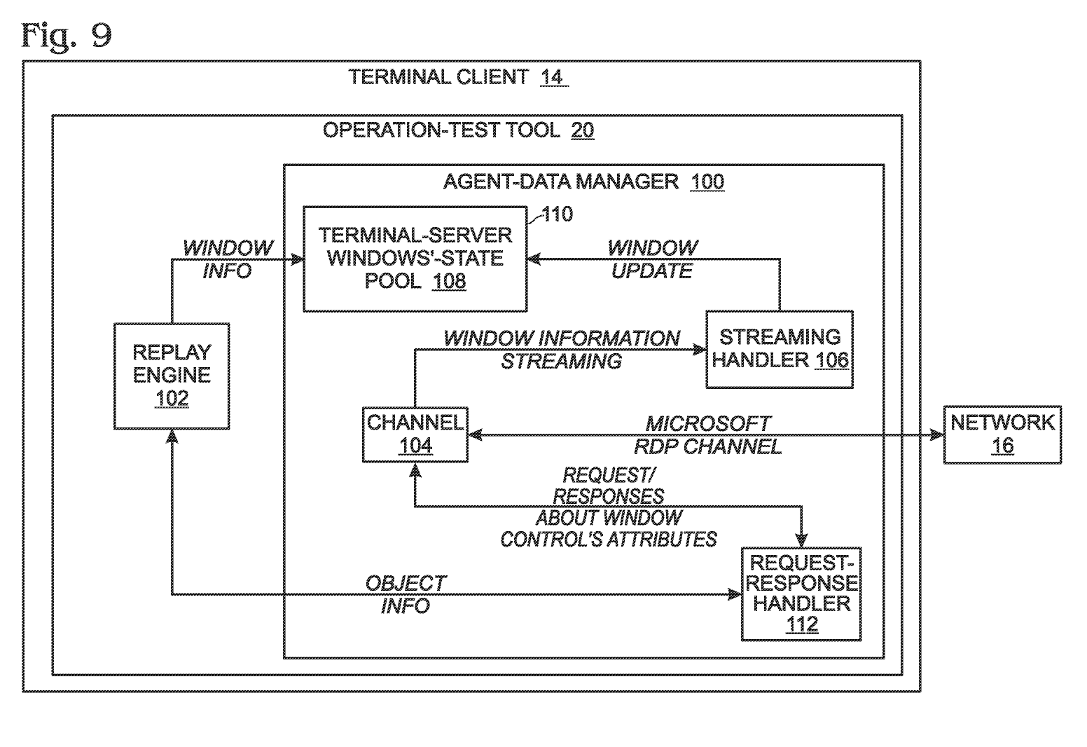

FIG. 9 is a functional block diagram of an example of a terminal client 14 with an operation-test tool 20. Operation-test tool 20 may include an agent-data manager 100 configured to manipulate agent data during recording and replaying of a script. The agent-data manager may provide an interface between a replay engine 102 used during replay and the terminal-services agent 22 on the terminal server.

Streaming windows messages from terminal-services agent 22 may be received on the corresponding communications channel over network 16 at a network interface 104. The streaming windows information may then be forwarded to a streaming handler 106 that may use the windows information to update a terminal-server windows-state pool 108 stored on a processor-readable database 110. The windows-state pool may serve as a log of windows information for use in an operation (function or load) test script.

Requests for object information that are input by a user of terminal client 14 may be received by a request-response handler 112. The requests may be formulated as messages that are then communicated to the terminal-services agent via network interface 104 and network 16 over the response-request communication channel. Responses received by network interface 104 may then be forwarded to the request-response handler. The request-response handler then sends the object information contained in the response to replay engine 102, which in turn adds it to the terminal-server windows state pool 108.

FIG. 10 illustrates an example of a portion of a script that may be generated using the information received from the terminal services agent. In this example script steps may be given descriptive names according to the activated window to which they relate. Further, a tree-structure may be produced that groups script entries according to window titles, Such as “Start Menu,” “Run,” and “Save As.” It is seen that in this example, script entries related to a “Save As” window includes additional window-information based events, such as “sync Object Mouse Click” and “Sync on Window.” Such a script organization tends to follow application progress by the application-specific windows and associated events. Such an organization and naming convention may facilitate the understanding of the script by a user familiar with the application.

The run-time windows-based information thus allows the operation-test tool to create synchronization steps before keyboard events. Images during replay may closely resemble images during recording with the window-detail being used. With these tools, large scale, robust, easy-to-maintain load tests may be created faster and easier, and less manual work may be needed before a test is ready to run. The operation-test tool also may use reduced CPU time, which may be significant when generating concurrent instances for load testing. The script produced also may be more readable that desktop-image-based scripts, especially when the scripts contain long and complicated business processes.

What is claimed is:

1. A method of producing or executing a script for an operation test of a terminal server, the method comprising:
during execution of a high-level application by the terminal server controlled by a user of a terminal client in which the terminal client and terminal server communicate according to remote-desktop protocol, monitoring by a terminal-services agent on the terminal server a change in at least one window of the high-level application within a terminal-client desktop of the terminal client;
sending window-related information corresponding to the monitored change from the terminal-services agent to an operation-test tool resident on the terminal client; and
logging by the operation-test tool the received window-related information.

2. The method of claim 1, wherein sending windows-related information occurs only when the change is of a type that is in a given group of types of changes.

3. The method of claim 2, wherein sending windows-related information occurs when the change is one or more of window creation, window size, window state, window position, and window title.

4. The method of claim 1, further comprising, prior to monitoring changes, opening a first communication channel between the terminal-services agent to the operation-test tool, and wherein sending windows-related information includes sending the windows-related information to the operation-test tool via the first communication channel.

5. The method of claim 4, further comprising opening a second communication channel between the terminal-services agent and the operation-test tool,

6. The method of claim 5, further comprising sending from the operation-test tool over the second communication channel to the terminal-services agent a request for specified run-time information on an attribute of the window, and wherein sending the run-time information includes sending the specified run-time information in response to the request for the specified run-time information.

7. The method of claim 6, wherein sending the request for specified run-time information includes sending the request for one or more of information of a window-control object, window text, window title, and window position.

8. An operation-test system for producing or executing an operation-test script, the operation-test system comprising:
a terminal client including an operation-test tool; and
a terminal server including a terminal-services agent and being configured to execute a high-level application according to input received from the terminal client; and
a communication link providing communication between the terminal server and the terminal client according to remote-desktop protocol;
the terminal-services agent being configured to monitor a change in an application window for the high-level application within a client-desktop display image during execution of the high-level application, and to send window-related information corresponding to the monitored change to the operation-test tool; and
the operation-test tool being configured to log the received window-related information.

9. The system of claim 8, wherein the terminal-services agent is further configured to send the windows-related information only when the change is of a type that is in a given group of types of changes.

10. The system of claim 9, wherein the terminal services agent is configured to send the windows related information when the change is one or more of window creation, window size, window state, window position, and window title.

11. The system of claim 8, wherein the terminal-services agent is further configured to open a first communication channel with the operation-test tool, and to send the windows-related information to the operation-test tool via the first communication channel.

12. The system of claim 11, wherein the terminal-services agent is further configured to open a second communication channel with the operation-test tool, the load test tool is configured to send over the second communication channel to the terminal-services agent a request for specified run-time information on an attribute of the window from the terminal-services agent to the operation-test tool.

13. The system of claim 12, wherein the load test tool is configured to send over the second communication channel to the terminal-services agent a request for specified run-time information on content of the window, and the terminal-services agent is configured to send the specified run-time information in response to the request for the specified run-time information.

14. The system of claim 13, wherein the terminal-services agent is configured to send the request for the specified run-time information as one or more of information of a window-control object, window text, window title, and window position.

15. A computer-readable medium readable by one or more computers and having embodied therein a program of computer-readable instructions that, when executed by the one or more computers, provide for:
during execution of a high-level application by a terminal server controlled by a user of a terminal client in which the terminal client and terminal server communicate according to remote-desktop protocol, monitoring by a terminal-services agent on the terminal server a change in a window of the high-level application within a terminal-client desktop of the terminal client;
sending window-related information corresponding to the monitored change from the terminal-services agent to an operation-test tool resident on the terminal client; and
logging by the operation-test tool the received window-related information.

16. The computer-readable medium of claim 15, wherein the program of computer-readable instructions provides further for sending windows-related information only when the change is of a type that is in a given group of types of changes.

17. The computer-readable medium of claim 16, wherein the program of computer-readable instructions provides further for sending windows-related information when the change is one or more of window creation, window size, window state, window position, and window title.

18. The computer-readable medium of claim 15, wherein the program of computer-readable instructions provides further for, prior to monitoring the change, opening a first communication channel between the terminal-services agent and the operation-test tool, and sending the windows-related information to the operation-test tool via the first communication channel.

19. The computer-readable medium of claim 18, wherein the program of computer-readable instructions provides further for opening a second communication channel between the terminal-services agent and the operation-test tool, and sending run-time information on an attribute of the window from the terminal-services agent to the operation-test tool.

20. The computer-readable medium of claim 19, wherein the program of computer-readable instructions provides further for sending over the second communication channel to the terminal-services agent a request for specified run-time information on content of the window, and sending the specified run-time information over the second communication channel in response to the request for the specified run-time information.
